(19) United States
(12) Patent Application Publication
(10) Pub. No.: US 2017/0191849 A1
(43) Pub. Date: Jul. 6, 2017

(54) PARKING AVAILABILITY SYSTEM

(71) Applicant: SAP SE, Walldorf (DE)

(72) Inventors: Sharon Agam, Herzlia (IL); Eyal Barlev, Hod Hasharon (IL); Ido Perez, Lehavim (IL); Lior Frenkel, Natanya (IL)

(21) Appl. No.: 15/380,929

(22) Filed: Dec. 15, 2016

Related U.S. Application Data
(60) Provisional application No. 62/273,098, filed on Dec. 30, 2015.
(60) Provisional application No. 62/306,156, filed on Mar. 10, 2016.

(51) Int. Cl. G01C 21/36

(52) U.S. Cl. CPC G01C 21/3685; G01C 21/3641; G07B 15/00

(57) ABSTRACT

In an implementation, parking-related statistical and real-time data and data received from routing data providers is normalized as normalized data. Using the normalized data, a computer calculates a probability for parking space availability in given geographical segments for a selected destination, routes to available parking, probability, and an estimated time to park (ETP)=estimated time to drive around (ETDA)+estimated time to walk (ETW) using the normalized statistical data and the selected destination. The calculated routes to available parking are evaluated in combination with user preferences to rank the calculated routes to available parking. The ranked routes to available parking are initiated for display on a graphical user interface (GUI).

### CLAIM OF PRIORITY

This application claims priority under 35 USC §119(e) to U.S. Patent Application Ser. No. 62/273,098, filed on Dec. 30, 2015, and also to U.S. Patent Application Ser. No. 62/306,156, filed on Mar. 10, 2016, the entire contents of each and both Provisional applications are hereby incorporated by reference.

### BACKGROUND

In metropolitan areas, the ability to obtain real-time parking information is very important, for example, to ensure the ability to make appointment times, ensure the steady flow of commerce, maximize the use of available time and resources, and to minimize automotive accidents. In other words, the ability to obtain real-time parking information helps avoid financial, social, and environmental waste. Currently, however, parking information which can be found is of limited coverage, inaccurate, and not widely available for user consumption at a cost-effective price.

### SUMMARY

The present disclosure describes methods and systems, including computer-implemented methods, computer program products, and computer systems for providing real-time parking information.

In an implementation, parking-related statistical and real-time data and data received from routing data providers is normalized as normalized data. Using the normalized data, a computer calculates a probability for parking space availability in given geographical segments for a selected destination, routes to available parking, probability, and an estimated time to park (ETP)=estimated time to drive around (ETDA)+estimated time to walk (ETW) using the normalized statistical data and the selected destination. The calculated routes to available parking are evaluated in combination with user preferences to rank the calculated routes to available parking. The ranked routes to available parking are initiated for display on a graphical user interface (GUI).

The above-described implementation is implementable using a computer-implemented method; a non-transitory, computer-readable medium storing computer-readable instructions to perform the computer-implemented method; and a computer-implemented system comprising a computer memory interoperably coupled with a hardware processor configured to perform the computer-implemented method/the instructions stored on the non-transitory, computer-readable medium.

The subject matter described in this specification can be implemented in particular implementations so as to realize one or more of the following advantages. First, at a high-level, the described parking solution provides a single, consistent, scalable, and robust end-to-end experience comprising a Parking Availability Service, a white-label software application, and a parking availability provider-consumer marketplace. Second, the described solution aggregates on- and off-street parking availability; exposing parking availability data as well as providing a routing service (for example, an administrator can configure that the solution should only use particular data/service sources) that maximizes the chances of finding a parking space. Third, the white-label software application (for example, a mobile application) assists drivers to find parking based on information provided by the solution. Fourth, the provided white-label software application provides feedback to the solution based on the drivers' actual parking experience to enhance the solution's functionality. Fifth, the provided provider-consumer marketplace connects parking data providers to consumers with data channels, such as mobile application vendors of navigation applications, parking payment applications, etc. Data channels can also be vehicle makers or any other consumer of parking availability data. Sixth, the solution includes a cloud platform that can serve clients in available locations with a native, white label mobile application. The cloud platform is typically configurable per city and processes all available data sources (DS) into a database. Seventh, the solution can leverage dynamic pricing to encourage/discourage parking in specific locations, parking time, etc. Other advantages will be apparent to those of ordinary skill in the art.

The details of one or more implementations of the subject matter of this specification are set forth in the accompanying drawings and the description below. Other features, aspects, and advantages of the subject matter will become apparent from the description, the drawings, and the claims.

### DESCRIPTION OF DRAWINGS

FIG. 1 is a high-level block diagram illustrating an example distributed computing system (EDCS) for providing a real-time parking availability service (PAS), according to an implementation.

FIG. 2 is a block diagram illustrating a more detailed view of the EDCS of FIG. 1 for providing the real-time PAS, according to an implementation.

FIG. 3 is a block diagram illustrating a low-level view of the EDCS of FIGS. 1 and 2 for providing a real-time PAS, according to an implementation.

FIG. 4 is a block diagram illustrating an example solution flow for the EDCS 100 of FIGS. 1-3 for providing a real-time PAS, according to an implementation.

FIG. 5A is a flowchart of an example method for aggregation functionality, according to an implementation.

FIG. 5B is a legend for symbols present in FIG. 5A, according to an implementation.

FIG. 6 is a flowchart of an example method for dynamic pricing, according to an implementation.

FIG. 7 is a flowchart of an example method for providing real-time parking information, according to an implementation.

FIG. 8 is a flowchart of an example method for social parking, according to an implementation.

FIG. 9 is a block diagram illustrating an exemplary computer system used to provide computational functionalities associated with described algorithms, methods, functions, processes, flows, and procedures as described in the instant disclosure, according to an implementation.

Like reference numbers and designations in the various drawings indicate like elements.

### DETAILED DESCRIPTION

The following description is presented to enable any person skilled in the art to make and use the disclosed subject matter, and is provided in the context of one or more particular implementations. Various modifications to the disclosed implementations will be readily apparent to those skilled in the art, and the general principles defined herein may be applied to other implementations and applications without departing from scope of the disclosure. Thus, the present disclosure is not intended to be limited to the described and/or illustrated implementations, but is to be accorded the widest scope consistent with the principles and features disclosed herein.

In metropolitan areas, the ability to obtain real-time parking information (for example, availability of parking spaces) is very important, for example, to ensure the ability to make appointment times, ensure the steady flow of commerce, maximize the use of available time and resources, and to minimize automotive accidents. In other words, the ability to obtain real-time parking information helps avoid financial, social, and environmental waste (for example, increased carbon emissions by vehicles, time loss for business and personal purposes, and financial loss to businesses and services).

The increase in vehicle ownership ratios globally is causing the general availability of parking spaces to decrease. As an example, traffic congestion (particularly at travel end points) is exacerbated largely due to vehicles searching for parking spaces.

Parking information is crucial for all drivers, particularly in any large metropolitan area. Due to lack of parking information, drivers end up spending a significant amount of time searching for a parking spot, which can exacerbate, for example, traffic congestion, result in automotive accidents, etc. Currently, however, there is no easy and convenient way to get real-time information regarding parking availability into a global range of cities. Moreover, available parking information is of limited coverage, inaccurate, and not cost-effective.

Described, at a high-level, is a consistent, scalable, computer-implemented, and cloud-computing-networked, Parking Availability Service (PAS) for providing parking information and associated services. The PAS supports both consumer and provider clients. For example, consumers can leverage provided parking information to optimize finding a parking space and to mitigate parking issues (for example, those listed above) associated with vehicular transportation and parking. Providers can integrate data/products/services (for example, applications, payment systems, routing information, events, social services, etc.) for consumption (for example, by drivers, auto makers, or other consumers of parking availability data).

In typical implementations, the PAS provides data and services through a mobile application (for example, a native, white-label, in-vehicle installed application solution, or other mobile application) executing on a mobile computing device taking into account, for example, local parking rules, driving time required to get to the parking space, walking time to final destination, and various driver preferences. The mobile application can also be configured to leverage one or more hardware/software features of the mobile computing device (for example, digital cameras, light sensors, gyroscope, accelerometer, other mobile applications, etc.) to enrich provided data and services, provide data to the PAS (for example, for feedback or crowd sourcing purposes), and other functions consistent with this disclosure. An in-vehicle installed solution could, for example, be installed by an auto maker and include both hardware and software integrated with an automobile (such as applications, sensors, digital cameras, etc.) that can be used by the PAS to provide the above-mentioned and other functions consistent with this disclosure.

In a typical implementation, example services provided by the PAS can include, but are not limited to, on-street parking space availability (for example, exposing parking space availability data as well as a routing service that maximizes the chances of finding a parking space (for example, an administrator can configure that the solution should only use particular data/service sources) and provides a most efficient route to the parking space given current road, weather, event, etc. conditions), social parking, dynamic pricing, cashless payments, system feedback based on a driver's parking experience. Other available services will be apparent from the overall disclosure and are considered to be within the scope of this disclosure.

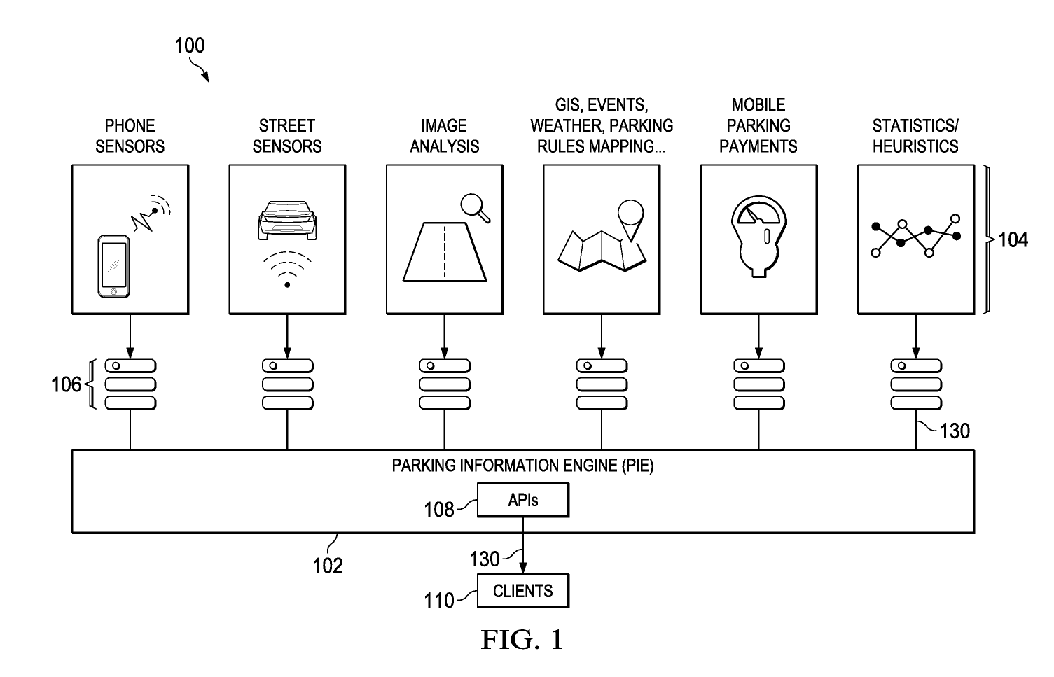

FIG. 1 is a high-level block diagram illustrating an example distributed computing system (EDCS) 100 for providing a real-time PAS, according to an implementation. In typical implementations, the EDCS 100 includes a Parking Information Engine (PIE) 102, data/service sources 104, sources servers 106, and APIs 108 (as part of PIE 102) for providing parking information to Clients 110 (for example, mobile computing devices, service providers, municipalities, and other clients). Components of the EDCS 100 are connected using a network 130. Note, that in the following figures, even though all connections between components are not explicitly labeled as network 130, in typical implementations, component connections are considered be connected by a network 130, multiple networks (including computing system internal data/processing buses) acting together as a network 130.

At a high-level, the PIE 102 receives and aggregates parking-related data and provides third-party services for Clients 110 (both consumers and providers) of parking information data. APIs 108 provide standardized, optimized access to the PIE 102 for the Clients 110.

Data/service sources 104 includes received and aggregated parking-related proprietary as well as public data and provided third-party services for Clients 110. Parking-related data includes, for example, phone sensors, street sensors, image analysis, geographic information system, weather, parking, and mapping data. Third-party services include, for example, parking payments, parking data (including the previously-mentioned parking-related data), routing, and statistics/heuristics.

Sources servers 106 are used by the data/service sources 104 to, for example, aggregate, pre-process, cross-reference, normalize, and the like (including other functions consistent with this disclosure). parking-related data (for example phone sensor, street sensor, and image analysis data) and to provide APIs, data, etc. to permit service sources to provide parking-related services (for example, parking related payments, route planning, etc.) through the PIE 102 to the consumers 110.

In typical implementations, the PIE 102 aggregates data received from the data/service sources 104/sources servers 106 into an internal database and used to provide more robust and rich data/services to providers or consumers than single or limited data sources typically permit. In some implementations, the aggregated data can be processed by machine learning, artificial intelligence, or other algorithms and the resultant data used to provide the additional data/services for providers or consumers (for example, analytics, navigation, routing, historical/predictive, and other data/services). In some implementations, the described solution can be configured to aggregate on a limited basis with particularly selected data/service sources (not all data/service sources interfaced with the solution).

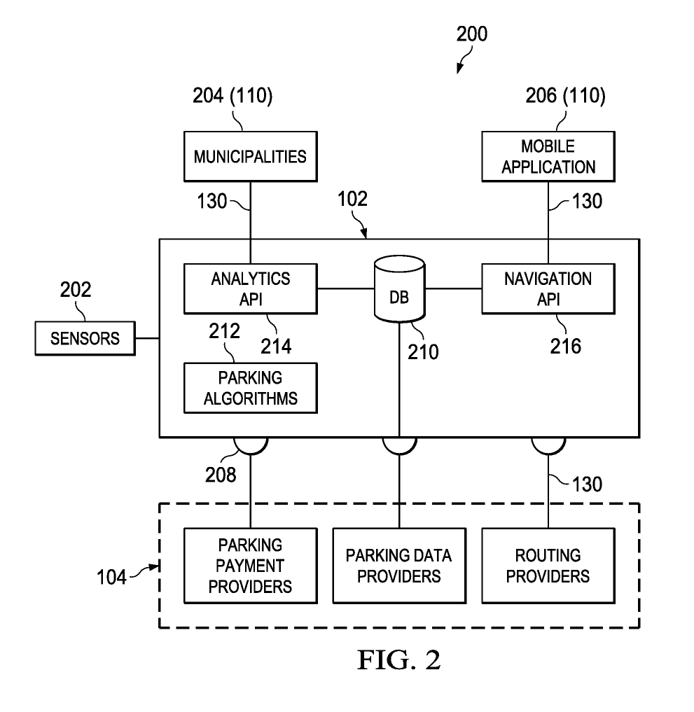

FIG. 2 is a block diagram 200 illustrating a more detailed view of the EDCS 100 of FIG. 1 for providing a real-time PAS, according to an implementation. In typical implementations and as illustrated in FIG. 2, the EDCS 100 includes Parking Information Engine (PIE) 102, Sensors 202, Municipalities 204, Mobile Application 206, and data/service sources 104 (here identified as, Parking Payment Providers, Parking Data Providers, and Routing Providers).

Sensors 202 can include hardware/software (for example, mobile phone digital cameras, accelerometers, gyroscopes, and the like) providing additional data to the PIE 102 apart from data/service sources 104. The use of sensor 202 data can enhance the analytics, navigation, routing, and other data/services provided by the PIE 102.

Municipalities 204 (a Client 110 in FIG. 1) can include businesses, universities, towns, cities, states, and other population centers that wish to consume parking-related analytics data (here illustrated interfacing with the Analytics API 214) and services provided by the PIE 102. The provided parking-related analytics data and services enable the Municipalities 204 to effectively manage parking and to encourage potential drivers to rely on other modes of transportation. Reasons can vary to take advantage of the other modes of transportation, for example the wish to reduce carbon emission, avoid chaotic traffic jams, redirect traffic, or to differentiate between city dwellers and visitors. The provided parking-related analytics data and services can be used to, among other things consistent with this disclosure, making parking more efficient (using maps, such as heat maps, routing maps, and estimated time of arrival (ETA) data, to indicate available parking and efficient routing), reduce parking congestion, wasted time, and wasted fuel, while improving speed and reliability of public transit, access to businesses/municipal services, and road safety.

Municipalities 204 can also provide parking information (for example, as a data/service source 104 to the PIE 102. For example, the Municipalities 102 can provide parking regulations, cost data, available parking spaces and geographic locations, and the like to the PIE 102 for use in providing the PAS to clients 110. Municipalities 204 can also work to integrate sensors (such as, magnetic, visual, etc.) to provide parking information as data points to the PIE 102 and other components of the EDCS 100. In typical implementations, the EDCS 100 is configurable (for example, data sources, service providers, local regulations, etc. to use in providing the PAS) for each particular Municipality 204 to permit optimization of the PAS for each particular Municipality 204.

Mobile Application (a Client 110 in FIG. 1) can include applications for smart phones, tablet computers, laptops, in-vehicle navigation systems, smart-watches, and other mobile-type devices capable of receiving, processing, and providing the PAS to Clients 110. In some implementations, Mobile Application 206 can be a consistent white-label application that can be re-branded for use by different services providing Client 110 access to the PAS/PIE 102 (as consumers or producers).

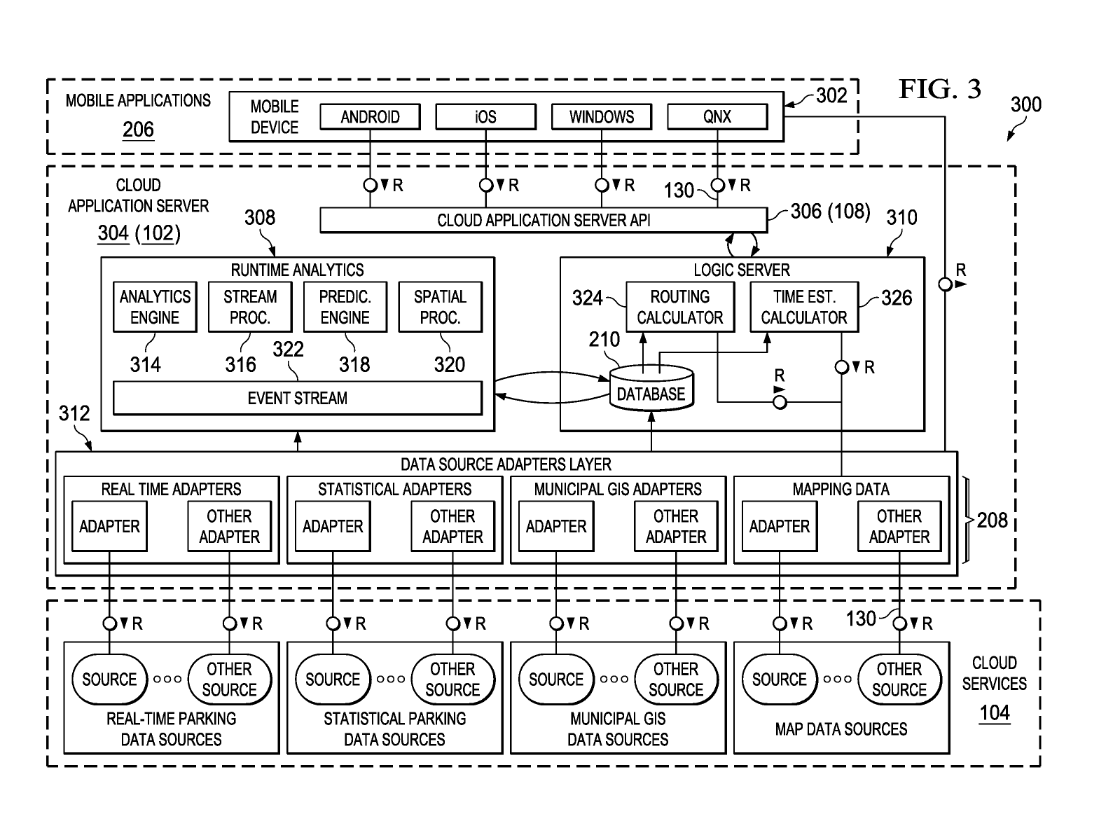

As illustrated, Mobile Application 206 is interfaced with the PIE 102 through a Navigation API 216 (providing access to navigation functions described in more detail in FIG. 3) and Municipalities 204 is interfaced with the PIE 102 through an Analytics API 214 (providing access to analytics functions described in more detail in FIG. 3), however, as will be appreciated by those of ordinary skill in the art, the Mobile Application 206, the Municipalities 204, and other Clients 110 can interface with the PIE 102 using other APIs (represented in general by API 108 in FIG. 1) whether or not illustrated. Other example APIs can include, but are not limited to, heat maps, ETA, routing, and other APIs not illustrated in the figures of this disclosure. Other APIs consistent with this disclosure are considered to be within the scope of this disclosure.

Mobile Application 206 can also provide feedback-type data (either automated or Client-initiated) to the PIE 102. For example, a Client 110 can provide ratings data on the data (for example, routing, parking space availability, ETA calculations, etc.) shown in the Mobile Application 206 as provided by the PAS. This ratings data can be used to adaptively weight data from data/service sources 104 for future processing, analytics, etc. by the PIE 102. Higher weighted data/service sources will be prioritized in processing, analytics, etc. The Mobile Application 206 can, in some implementations, also be used to provide real-time crowd-source-type data to enhance the PAS provided by the PIE 102. For example, an accident occurring at the entrance to a parking lot could be indicated by a Client 110 in the Mobile Application 206. This data could be used by the PIE 102 to update parking availability data to indicate that the parking spaces in the affected parking lot are unavailable for a predicted amount of time. This data can also be used by the PIE 102 to update parking availability heat maps, ETA calculations, and routing information for Clients 110 in the immediate geographical area. Mobile Applications 206 can be optimized for the hardware devices they execute on. For example, a particular Mobile Application 206 can be optimized to leverage available mobile device sensor devices to their optimum capacity for use by the Client 110 and one or more components of the EDCS 100.

In some implementations, the Mobile Application 206 can expose additional features to simplify the search for parking spots. For example, the additional features could include quickly changing personal preferences from default values and receiving suggestions for changes to personal preferences based on Client 110 actions over time. Navigation can be chosen to be performed by the Client 110's favorite navigation system or a native navigation system included as part of the Mobile Application 206. The described PAS would pop up on/in place of the Client 110's navigation system just before, for example, the last mile to the Client 110's desired destination to navigate the Client 110 to the destination. In some implementations, the PAS would present to the Client 110, a detailed GUI with enhanced information about a suggested parking space as an option (for example, exact location, price/hr., parking rules, payment options, etc.). Once parked, the Client 110 could be presented with a walking or public transformation route to the intended destination.

In some implementations, software development kits (SDKs) can be embedded at the application level (for example, in the Mobile Application 206), where it is the responsibility of an application (not the PIE 102) to convert sent data into whatever format needed (for example, map coordinates, map routes, etc.). This configuration can reduce calculations on the server-side (and turn a “thin” client into “fat” client).

In some implementations, the PAS can also provide a “parking swap” social parking option which allows another PAS Client 110 to be notified when a parked Client 110 is returning to their vehicle. For example, the driving Client 110 could be presented with a request to swap the parking spot and running a smart bid system for nearby Clients 110. Special credits can be offered to the parked Client 110 agreeing to swap the parking space with another Client 110.

In some implementations, provided features could also include saved parking, otherwise a ticket (for example, a parking spot is saved for a specific driver. If someone else parks there, they can receive a ticket. The driver can reserve the parking x minutes before arrival to the parking spot (the driver can pay when he reserves the parking). If the driver does not arrive during those x minutes, the parking spot will be freed for use by others (for example, a penalty system could be implemented if the driver does not arrive in a particular time frame), dynamic heat mapping (a map showing parking conditions and/or parking suitable for personal preferences of a Client 110. Heat maps will not be the same for two drivers who are looking for parking at the same location. In some implementations, the Mobile Application can be configured to block streets (will not display them as available) in order to ensure that a particular driver can find a parking space (based on, but not limited to, pricing or fairness (such as, first-in first-out))), park and shuttle (for example, drivers can park where there is a lot of parking space and shuttles can take them (free of charge or not) to their destination (great for sport events, conventions, etc.)) and user rating (for example, a Client 110 can rate performance of a particular data/service source (such as, according to: time in the day, location in the city, time and location in the city, etc.)).

Other additional features could gamification functionality, including, among other things, providing invitation codes to a Client 110 to invite friends, colleagues, family, etc. to use the PAS. Parking credits can be offered as a reward to the Client 110 following additional signups with the shared invitation codes. The PAS can also be integrated with Client 110 personal calendars and intelligently suggest parking routes/options based on scheduled events, past usage history, and the like.

Data/service sources 104 are illustrated in FIG. 2 as Parking Payment Providers, Parking Data Providers, and Routing Providers). In some implementations, Parking Payment Providers can provide, for example, hardware, software, and infrastructure to provide mobile, cashless, payments (for example using the Mobile Application 206) for Clients 110. In some implementations, Parking Data Providers can provide, for example, mobile device sensor signal processing for mobility and parking status analysis, Client 110 status with respect to when the need for current parking will end (such as using geo-data/geo-fencing to detect that the Client 110 is returning to their parked vehicle), providing social services (for example, social/peer-to-peer parking services, physical parking space sensor data (for example, using a magnetometer or other sensors), geographic information system (GIS) system data, Municipalities 204 parking information, real-time generated data (such as, determining lack of parking because a Client 110 cannot stop at their final destination), translation of real-time city/satellite images (for example, images of available parking spaces from a mobile device digital camera while driving), and crowd-sourcing data. In some implementations, Routing Providers can be selected based on, for example, comprehensive data for a particular geographic area(s) or particular services required, to provide, for example, routing, ETA, and map data. Other data that can be provided to the PIE 102 includes, weather, local events, flight information, and the like. Any data consistent with this disclosure that can be used to provide parking information and the PAS is considered to be within the scope of this disclosure.

The PIE 102 typically includes data/service adaptors 208 (for example, illustrated connected to Parking Payment Providers), a Database 210, Parking Algorithms 212, and the Analytics API 214/Navigation API 216 (both described above). Note that, in some implementations, the Analytics API 214 and the Navigation API 216 can be considered to be part of the API 108 as illustrated in FIG. 1.

Data/service adaptors 208 provide defined APIs and other interfaces between data/service sources 104 and the PIE 102. In other words, the data/service adaptors 208 permit connection of parking (and other) data/service providers to different software applications as part of the PIE 102 and other components of the EDCS 100. Using the data/service adaptors 208, the PIE 102 can aggregate data from data providers and interface provided services from service providers to supply the PAS to Clients 110.

Database 212 is used to receive and aggregated parking-related proprietary as well as public data. Database 212 can also implement logic necessary to process/perform calculations on the received parking-related data using both native and external logic/algorithms.

Parking Algorithms 214 are used to process aggregated parking-related data, sensors 202 data, and any other applicable data/service to optimize finding of a parking space by a Client 110. In some implementations, the Parking Algorithms 214 can include or leverage machine learning, artificial intelligence, or other algorithms (such as analytics, navigation, routing, and the like) to provide continuously improved parking information to Clients 110.

FIG. 3 is a block diagram 300 illustrating a low-level view of the EDCS 100 of FIGS. 1 and 2 for providing a real-time PAS, according to an implementation. Note that, as will be appreciated by those of ordinary skill in the art, the example EDCS 100 is only one possible implementation. Other implementations are also possible and, to the extent that they are consistent with this disclosure, are considered to be within the scope of this disclosure. The example EDCS 100 is not intended to limit the described subject matter in any way.

In typical implementations and as illustrated in FIG. 3, the EDCS 100 includes a Mobile Device 302, such as a smart phone, table computer, laptop, or other mobile device, and containing multiple Mobile Applications 206 for mobile operating systems (for example, ANDROID, IOS, WINDOWS, QNX), a Cloud Application Server 304 (the PIE 102 as described in FIGS. 1 and 2), and data/service sources 104. In some implementations, some features available to Clients 110 using the Mobile Application 206 can include proposals made for items and services (payable though the Mobile Application 206) near a chosen parking space and on a walking route from the parking space and detection/notification in real-time of parking spaces that are about to vacated.

The Cloud Application Server 302 (PIE 102) includes a Cloud Application Server API 306 (API 108 as in FIG. 1), Runtime Analytics 308, Logic Server 310, and open API Data Source Adaptors Layer 312. The Cloud Application Server API 306 provides API connections between the Cloud Application Server 302 (PIE 102) and Mobile Applications 206 using one or more previously-described APIs.

Runtime Analytics 308 provides analytics services for the Cloud Application Server 302 (PIE 102) to provide to Clients 110 (consumer or provider). The Runtime Analytics 308 can include, for example, an Analytics Engine 314, an Event Stream Processing Engine 316, a Predictive Engine 318, and a Spatial Processing Engine 320.

The Event Stream Processing Engine 316 can process processes high-velocity, high-volume Event Stream 322 data in real time, allowing filtering, aggregation and enrichment of raw event stream data received from the Data Source Adaptors Layer 312 and make processed Event Stream 322 data available for the Analytics Engine 314, Predictive Engine 318, and Spatial Processing Engine 320 to provide analytics data to Clients 110. Event Stream 322 data can be stored in the database 210 for availability to various logic functions, Client 110 needs, etc. In some implementations, and as illustrated in FIG. 2, the Runtime Analytics 308 can use the Analytics API 214 to transfer data to a Client 110 (Municipalities 204).

In some implementations, all calculations are performed by the Spatial Engine 320. The Spatial Engine 320 can provide auto aggregation, so instead of seeing multiple points, one line of color per street section can be presented to a Client 110 based on a calculated parking probability. Similarly, when zooming in/out on a GUI an aggregation is calculated automatically as well as a summary window that changes in real-time. The described system can also create a polygon to further refine results.

Logic Server 310 performs various logic functions for the Cloud Application Server 302 (PIE 102) and contains the database 210. For example, Logic Server 310 is illustrated as containing both a Routing Calculator 324 and Time Estimation Calculator 326 (for ETA calculations). In some implementations, and as illustrated in FIG. 2, the Logic Server 310 can use the Navigation API 216 to transfer data to a Client 110 (Mobile Application 206).

The data/service sources 104 are illustrated as cloud services and integrated with the Cloud Application Server 304 (PIE 102) through data/service adaptors 208 in the Data Source Adaptors Layer 310. The Data Source Adaptors Layer 310 can normalize data sources into parking objects and use them in the event stream 322 in real-time, or save the parking objects to the database 210 for statistical analysis. In some implementations, each data/service source 104 (and there can be multiple of each type), is connected to the Cloud Application Server 304 (PIE 102) using a separate data/service adaptor 208. Note that the data/service sources 104 are intended to be consistent with the data/service sources 104 of FIGS. 1 and 2. In FIG. 3, the data/service sources 104 are illustrated as Real-time Parking Data Sources (for example, real-time parking availability in a given parking space), Statistical Parking Data Sources (for example, estimated parking availability as a probability based on recent historical data in a given road segment at a given point in time), Municipal GIS Data Sources (for example, parking capacity (inventory): paid vs. not-paid at specific times and days, disabled only, residents only, garbage collection days, cost of parking, etc.), and Map Data Sources.

Other functions (not explicitly illustrated) can also be performed by the illustrated EDCS 100. For example, mobile device/application billing functions and dynamic responsive pricing (for example, used to adjust parking space prices—using higher rates to create more turnover on the busiest blocks and to lower prices to draw drivers to blocks with underused spaces).

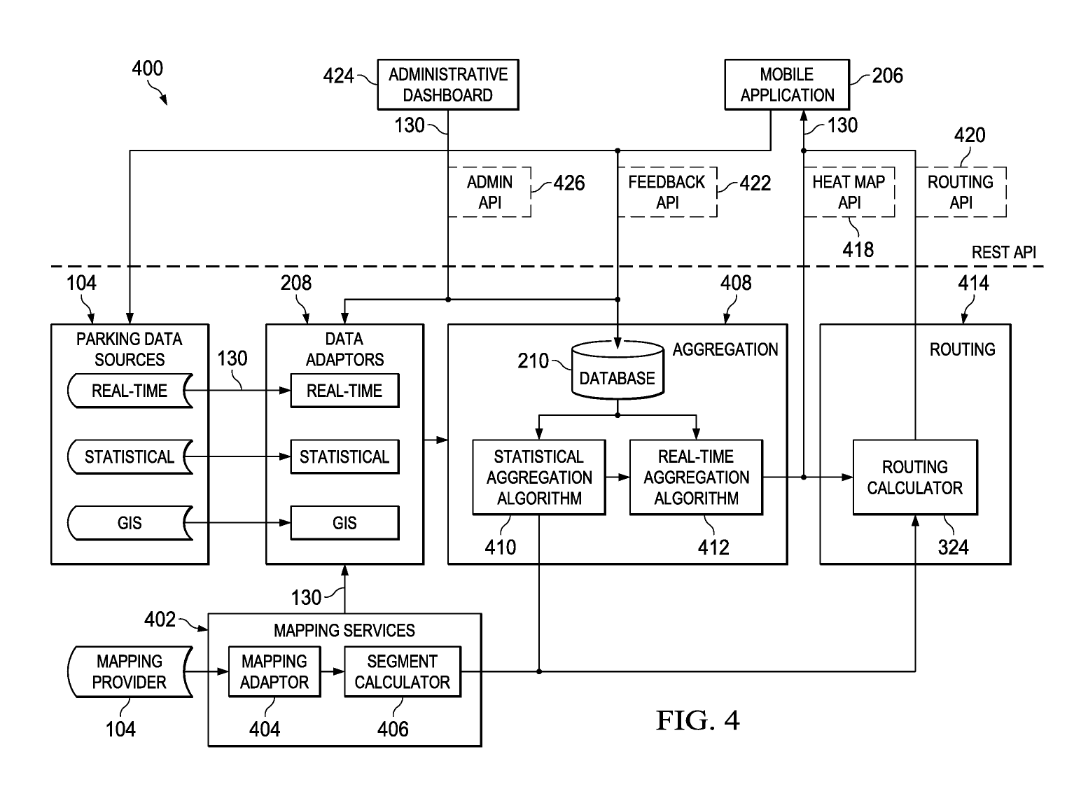

FIG. 4 is a block diagram 400 illustrating an example solution flow for the EDCS 100 of FIGS. 1-3 for providing a real-time PAS, according to an implementation. The example solution flow of FIG. 3 is not meant to be exhaustive, but to enhance understanding of the described material. As such, the example solution flow is not considered to limit the disclosure in any way.

As illustrated in FIG. 4, a Mapping Provider data/service source 104 passes mapping data to Mapping Services 402, where the mapping data is processed by a Mapping Adaptor 404 and Segment Calculator 406. The processed data is then transmitted to the EDCS 100 using a Data Adaptor 208. Similarly, Parking Data Sources 104 data (here illustrated as Real-time, Statistical, and GIS) is transmitted to appropriate Data Adaptors 208.

The Parking Data 104 and Mapping Provider service 104 is made available to an Aggregation component 408. The data is stored in database 210 and processed (as appropriate) using a Statistical Aggregation Algorithm 410 or Real-time Aggregation Algorithm 412.

Aggregated data is sent, using a heat map API 418, to a Mobile Application 206 and to a Routing component 414 and processed by a Routing Calculator 324. The processed routing data is transmitted, using a Routing API 420, to the Mobile Application 206 for Client 110 use. Feedback data can be transmitted to the Aggregation component 408 (for example, to store in the Database 210) and the Data Adaptors 208 using a Feedback API 422 (for example, from the Mobile Application 206).

The Administrative Dashboard 424 can be configured to provide administrative functionality (for example, Data Adaptor 208 connection, input, or throughput permissions, Aggregation function characteristics, etc.) for one or more components of the EDCS 100. For example, an administrator can use the Administrative Dashboard 424 to interface with and change attributes/functionality associated with one or more of the Data Adaptors 208 or Aggregation 408 using an Admin API 426.

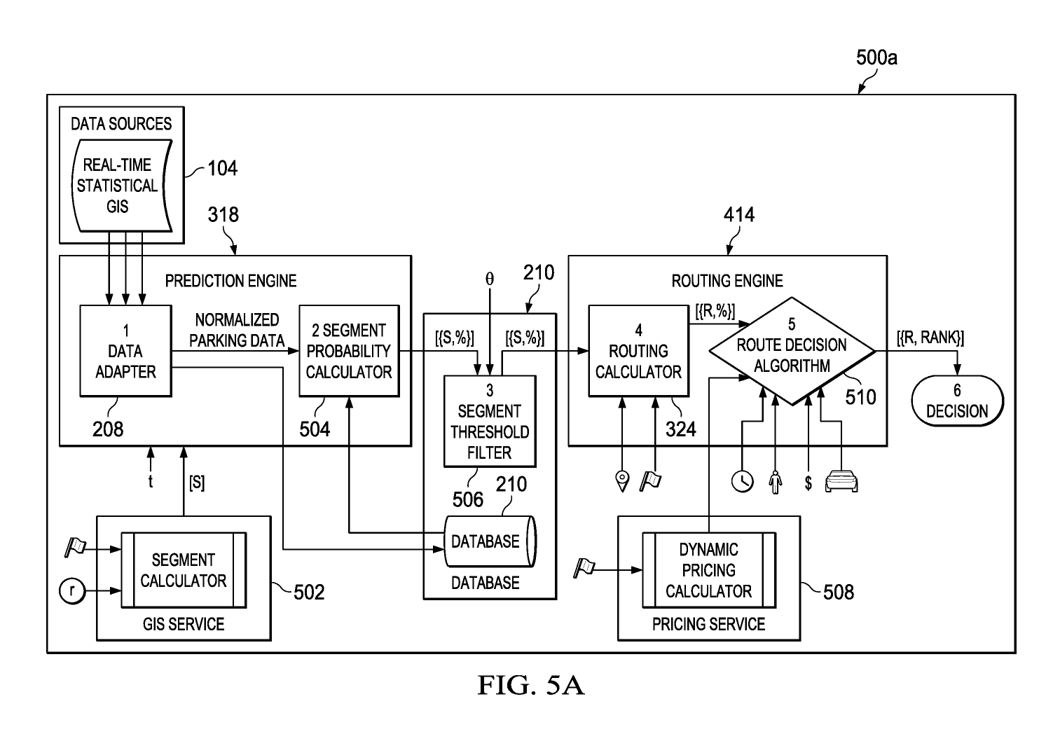

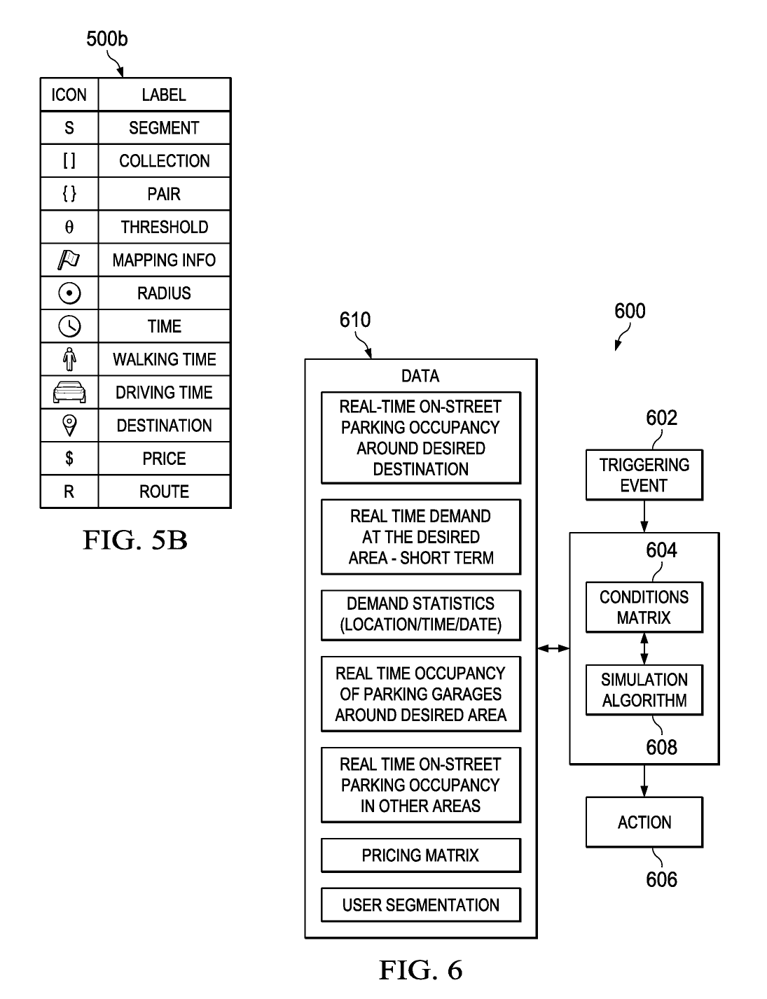

FIG. 5A is a flowchart of an example method 500a for aggregation functionality, according to an implementation. For clarity of presentation, the description that follows generally describes method 500a in the context of the other figures in this description. However, it will be understood that method 500a may be performed, for example, by any suitable system, environment, software, and hardware, or a combination of systems, environments, software, and hardware as appropriate. In some implementations, various steps of method 500a can be run in parallel, in combination, in loops, or in any order. Note that FIG. 5B is a legend 500b for symbols used in FIG. 5A, according to an implementation.

At 1, received data source 104 data is normalized using a Data Adaptor 208 and converted into one or more parking objects and stored in the database 210. The normalized data is also transferred to a Segment Probability Calculator 504. The GIS Service 502 uses mapping information and radius information to calculate a collection of segments used for route planning. From 1, method 500a proceeds to 2.

At 2, the Prediction Engine 318 uses time (time/day/date) and the collection of segments to calculate a probability of a Client 110 parking in a given segment according to time. From 2, method 500a proceeds to 3.

At 3, a Segment Threshold Filter 506 receives a collection of (segment, probability) value pairs from the Segment Probability Calculator 504 and filters the (segment, probability) value pairs according to a provided threshold to produce filtered data. From 3, method 500a proceeds to 4.

At 4, the Routing Calculator 324 (as part of routing engine 414) receives the filtered data, Client 110 destination, and mapping information and calculates routes, a probability, and an estimated time to park (ETP)=estimated time to drive around (ETDA)+estimated time to walk (ETW) according to statistical information and selected destination. From 4, method 500a proceeds to 5.

At 5, a data from a Pricing Service 508 (including mapping information) is used by a Route Decision Algorithm 510 to determine routes to propose a collection of ranked routes (for example, the top 3 routes can be presented to the Client 110 in the Mobile Application 206) to the Client 110 based on one or more of time, walking time, price, and driving time, etc. (for example, user preferences). In some implementations, the Route Decision Algorithm 510 can use a statistical conditional probability model and FLOYD-WARSHALL algorithm for finding shortest paths in a weighted graph. From 5, method 500a proceeds to 6.

At 6, a determination is made by the Client 110 as to which ranked route to select to use (for example, the second of three provided routes). After 6, method 500a stops.

FIG. 6 is a flowchart of an example method 600 for dynamic pricing, according to an implementation. For clarity of presentation, the description that follows generally describes method 600 in the context of the other figures in this description. However, it will be understood that method 600 may be performed, for example, by any suitable system, environment, software, and hardware, or a combination of systems, environments, software, and hardware as appropriate. In some implementations, various steps of method 600 can be run in parallel, in combination, in loops, or in any order.

There is typically more demand for parking than spaces available in city centers, and supply is typically undervalued (prices should be adjusted to reflect demand for a specific location). As described above, dynamic responsive pricing can be used to adjust parking space prices. Adjusting parking space prices can, among other things, (for higher rates) create more turnover on the busiest blocks and (for lower prices) to draw drivers to blocks with underused spaces, reduce carbon emissions, reduce traffic congestion, redirect traffic, etc. In some implementations, dynamic pricing can be determined by, but not limited to: statistical data−according to past information, real-time data, or statistical+real-time data.

A Triggering Event 602 occurs that invokes an action (for example, generated by meeting one or more logical rules/conditions) executed by an event-condition-action engine (not illustrated). An example of a triggering event could include a driver using the Mobile Application 206 to inform the PAS that they are looking for ON/OFF street parking and entering their desired destination and/or reaching a final mile while navigating to their desired destination.

In some implementations, a conditions matrix 604 (or other data structure) is configured with logical rules/conditions used to determine whether a triggering event has occurred. If a determination is made that a triggering event (for example, triggering event 602) has occurred, a defined action 606 to complete one or more logical rules/conditions can be invoked and output to a Client 110. In typical implementations, a simulation algorithm 608 estimates (continuously or on-the-fly) and simulates behavior and randomness of price changes. In typical implementations, data inputs 610 to the system can include one or more of real-time, on-street parking occupancy around a desired destination, real-time demand at the desired area—short-term, demand statistics, real-time occupancy of parking garages around a desired area, real-time on-street parking occupancy in other areas, a pricing matrix, and user segmentation.

In some implementations, a rules framework (for example, implemented within an in-memory database rules framework) can be implemented. The rules framework can assist in providing a simplified user interface for establishing logical rules/conditions and corresponding actions.

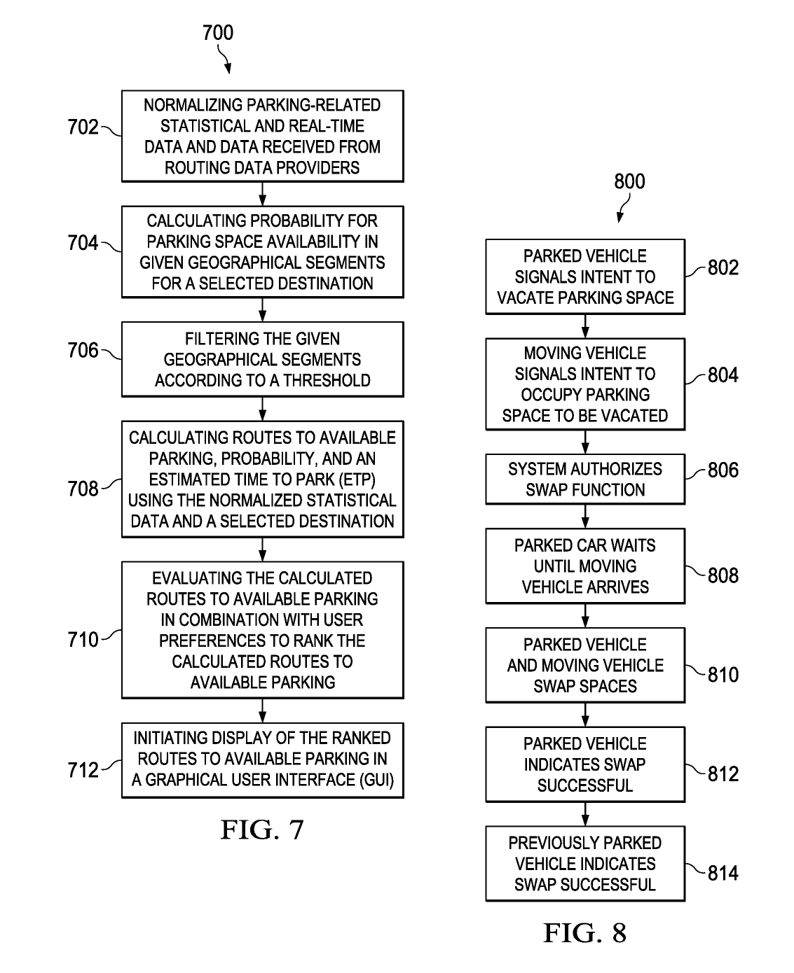

FIG. 7 is a flowchart of an example method 700 for providing real-time parking information, according to an implementation. For clarity of presentation, the description that follows generally describes method 700 in the context of the other figures in this description. However, it will be understood that method 700 may be performed, for example, by any suitable system, environment, software, and hardware, or a combination of systems, environments, software, and hardware as appropriate. In some implementations, various steps of method 700 can be run in parallel, in combination, in loops, and/or in any order.

At 702, parking-related statistical and real-time data and data received from routing data providers is normalized as normalized data. The parking-related statistical and real-time data includes data from one or more of mobile device sensors, street sensors, image analysis, geographic information system and mapping, and crowd sourcing data. In typical implementations the parking-related statistical and real-time data is aggregated. In typical implementations, the normalized data is stored in a database for access by a segment probability calculator used for the calculation of parking space probability. From 702, method 700 proceeds to 704.

At 704, calculating, by a computer using the normalized data, a probability for parking space availability in given geographical segments for a selected destination is calculated by a computer and using the normalized data. In typical implementations, the probability is calculated according to one or more of time, day, and date. From 704, method 700 proceeds to 706.

At 706, the given geographical segments are filtered according to a threshold. Thresholds can be set for any type of data and at any value consistent with this disclosure. From 706, method 700 proceeds to 708.

At 708, routes to available parking, probability, and ETP=ETDA+ETW are calculated using the normalized statistical data and the selected destination. From 708, method 700 proceeds to 710.

At 710, the calculated routes to available parking are evaluated in combination with user preferences to rank the calculated routes to available parking. In some implementations, the ranking is based on dynamic pricing. From 710, method 700 proceeds to 712.

At 712, the ranked routes are initiated for display. For example, the ranked routes can be presented to a user in a mobile application executing on a mobile device using a GUI. After 712, method 700 stops.

FIG. 8 is a flowchart of an example method 800 for social parking, according to an implementation. For clarity of presentation, the description that follows generally describes method 800 in the context of the other figures in this description. However, it will be understood that method 800 may be performed, for example, by any suitable system, environment, software, and hardware, or a combination of systems, environments, software, and hardware as appropriate. In some implementations, various steps of method 800 can be run in parallel, in combination, in loops, or in any order.

The following example of social parking, describes a driver of a parked car arranging to swap a parking space with a driver of a designated vehicle. In some implementation, the describe swap functionality is enabled for registered users of the described solution.

At 802, a parked vehicle signals intent to vacate a parking space. The system notifies nearby drivers of the soon-to-be vacant parking space. From 802, method 800 proceeds to 804.

At 804, a moving vehicle signals intent to occupy the parking space to be vacated. From 804, method 800 proceeds to 806.

At 806, the system authorizes the swap function and notifies the parked vehicle of the moving vehicle (for example, vehicle make, model, color, license plate, etc.). From 806, method 800 proceeds to 808.

At 808, the parked vehicle waits until the moving vehicle arrives to take the parking spot. From 808, method 800 proceeds to 810.

At 810, the parked vehicle and moving vehicle swap places with respect to the parking space. From 810, method 800 proceeds to 812.

At 812, the parked vehicle indicates to the system that the swap was successful. From 812, method 800 proceeds to 814.

At 814, the previously parked vehicle indicates to the system that the swap was successful. In some implementations, when a vacating driver swaps their parking space with another driver, they are awarded parking credits and are provided with an increase in “social” rank/priority over other drivers for future social functions using the PAS. After 814, method 800 stops.

In some implementations, a variation on the provided example can include that an occupied parking place does not have to be by a vehicle. It can be anything as long as the parking space is saved. For example a person standing in the parking spot, a physical cone, an electronic indication marking the spot as reserved, an automated gate, etc. are sufficient. Another variation can include that a Social Management System (SMS) administrator can configure if the SMS requires both the parked vehicle and the designated vehicle to report a successful swap or just one of the parties to initiate a report.

In typical implementations, the moving vehicle pays money to the parked vehicle for the privilege to swap for the parking space. Other gamification options can include paying with points, badges, swaps, etc. which can result in awards, vouchers, rewards based on meeting a particular goal in a specific time frame.

In typical implementations, a parked vehicle can determined by various methods. For example, methods can include a parked vehicle being predetermined (for example, a driver knows they will leave a location in a particular time frame and posts ahead of time about the upcoming space/vacancy. The system to identify the impending exact location on a map to drivers in the area), determined on-the-fly (a driver posts in real-time about an impending parking space vacancy as they are about to leave an occupied parking space), or be predetermined reoccurring (a driver posts ahead about a reoccurring parking space vacancy due to vacating a parking space on particular days as a set time).

In typical implementations, a designated vehicle can be determined by one or a combination of various methods. For example, first come-first served (for example, the designated vehicle will be determined by a closest ETA or distance to the parking space), parking space bidding (for example, once the parked vehicle has notified the system that it is about to vacate a parking space, all the vehicles will start bidding for the parking space (using money, points, etc.) and the highest bid will be chosen as the designated vehicle), parked vehicle choice (for example, once the parked vehicle has notified the system that it is about to vacate a parking space, it will get information about the vehicles from the SMS, and the parked vehicle will choose which vehicle will be the designated vehicle (for example, it will choose as it sees fit according to price, distance, ETA, etc.), parking space fix rate (for example, the vacating vehicle will get a fixed rate from the designated vehicle), rate/gamification rate according to size (the rate will be determined according to the size of the automobile. For example, the rate of a truck will be higher than the rate of a car), rate/gamification rate according to demand area (for example, the rate of the parking space will reflect the demand of the area. For example, the rate of a high demand parking space will be higher than the rate of a low demand parking space), social leader (for example, the driver who vacated the largest amount of parking spots will get priority while searching or ordering a parking space), donating a parking space (for example, the parked vehicle will wait until the designated vehicle will arrive and will swap places with no monetary return), and reoccurring (the designated driver knows that they will need a parking space every weekday day at set time. The driver can try getting single parking each time or agree with a reoccurring parked driver about several swaps ahead).

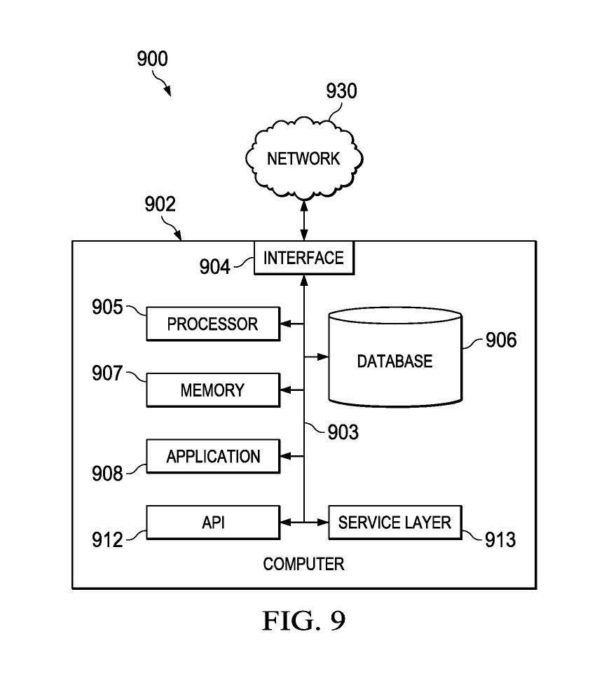

FIG. 9 is a block diagram of an exemplary computer system 900 used to provide computational functionalities associated with described algorithms, methods, functions, processes, flows, and procedures as described in the instant disclosure, according to an implementation. The illustrated computer 902 is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer 902 may comprise a computer that includes an input device, such as a keypad, keyboard, touch screen, or other device that can accept user information, and an output device that conveys information associated with the operation of the computer 902, including digital data, visual, or audio information (or a combination of information), or a graphical user interface (GUI).

The computer 902 can serve in a role as a client, network component, a server, a database or other persistency, or any other component (or a combination of roles) of a computer system for performing the subject matter described in the instant disclosure. The illustrated computer 902 is communicably coupled with a network 930 (for example, network 130). In some implementations, one or more components of the computer 902 may be configured to operate within environments, including cloud-computing-based, local, global, or other environment (or a combination of environments).

At a high level, the computer 902 is an electronic computing device operable to receive, transmit, process, store, or manage data and information associated with the described subject matter. According to some implementations, the computer 902 may also include or be communicably coupled with an application server, e-mail server, web server, caching server, streaming data server, or other server (or a combination of servers).

The computer 902 can receive requests over network 930 from a client application (for example, executing on another computer 902) and responding to the received requests by processing the said requests in an appropriate software application. In addition, requests may also be sent to the computer 902 from internal users (for example, from a command console or by other appropriate access method), external or third-parties, other automated applications, as well as any other appropriate entities, individuals, systems, or computers.

Each of the components of the computer 902 can communicate using a system bus 903. In some implementations, any or all of the components of the computer 902, both hardware or software (or a combination of hardware and software), may interface with each other or the interface 904 (or a combination of both) over the system bus 903 using an application programming interface (API) 912 or a service layer 913 (or a combination of the API 912 and service layer 913). The API 912 may include specifications for routines, data structures, and object classes. The API 912 may be either computer-language independent or dependent and refer to a complete interface, a single function, or even a set of APIs. The service layer 913 provides software services to the computer 902 or other components (whether or not illustrated) that are communicably coupled to the computer 902. The functionality of the computer 902 may be accessible for all service consumers using this service layer. Software services, such as those provided by the service layer 913, provide reusable, defined functionalities through a defined interface. For example, the interface may be software written in JAVA, C++, or other suitable language providing data in extensible markup language (XML) format or other suitable format. While illustrated as an integrated component of the computer 902, alternative implementations may illustrate the API 912 or the service layer 913 as stand-alone components in relation to other components of the computer 902 or other components (whether or not illustrated) that are communicably coupled to the computer 902. Moreover, any or all parts of the API 912 or the service layer 913 may be implemented as child or sub-modules of another software module, enterprise application, or hardware module without departing from the scope of this disclosure.

The computer 902 includes an interface 904. Although illustrated as a single interface 904 in FIG. 9, two or more interfaces 904 may be used according to particular needs, desires, or particular implementations of the computer 902. The interface 904 is used by the computer 902 for communicating with other systems in a distributed environment that are connected to the network 930 (whether illustrated or not). Generally, the interface 904 comprises logic encoded in software or hardware (or a combination of software and hardware) and operable to communicate with the network 930. More specifically, the interface 904 may comprise software supporting one or more communication protocols associated with communications such that the network 930 or interface's hardware is operable to communicate physical signals within and outside of the illustrated computer 902.

The computer 902 includes a processor 905. Although illustrated as a single processor 905 in FIG. 9, two or more processors may be used according to particular needs, desires, or particular implementations of the computer 902. Generally, the processor 905 executes instructions and manipulates data to perform the operations of the computer 902 and any algorithms, methods, functions, processes, flows, and procedures as described in the instant disclosure.

The computer 902 also includes a database 906 that can hold data for the computer 902 or other components (or a combination of both) that can be connected to the network 930 (whether illustrated or not). For example, database 906 can be an in-memory, conventional, or other type of database storing data consistent with this disclosure. In some implementations, database 906 can be a combination of two or more different database types (for example, a hybrid in-memory and conventional database) according to particular needs, desires, or particular implementations of the computer 902 and the described functionality. Although illustrated as a single database 906 in FIG. 9, two or more databases (of the same or combination of types) can be used according to particular needs, desires, or particular implementations of the computer 902 and the described functionality. While database 906 is illustrated as an integral component of the computer 902, in alternative implementations, database 906 can be external to the computer 902.

The computer 902 also includes a memory 907 that can hold data for the computer 902 or other components (or a combination of both) that can be connected to the network 930 (whether illustrated or not). For example, memory 907 can be random access memory (RAM), read-only memory (ROM), optical, magnetic, and the like storing data consistent with this disclosure. In some implementations, memory 907 can be a combination of two or more different types of memory (for example, a combination of RAM and magnetic storage) according to particular needs, desires, or particular implementations of the computer 902 and the described functionality. Although illustrated as a single memory 907 in FIG. 9, two or more memories 907 (of the same or combination of types) can be used according to particular needs, desires, or particular implementations of the computer 902 and the described functionality. While memory 907 is illustrated as an integral component of the computer 902, in alternative implementations, memory 907 can be external to the computer 902.

The application 908 is an algorithmic software engine providing functionality according to particular needs, desires, or particular implementations of the computer 902, particularly with respect to functionality described in this disclosure. For example, application 908 can serve as one or more components, modules, applications, etc. Further, although illustrated as a single application 908, the application 908 may be implemented as multiple applications 908 on the computer 902. In addition, although illustrated as integral to the computer 902, in alternative implementations, the application 908 can be external to the computer 902.

There may be any number of computers 902 associated with, or external to, a computer system containing computer 902, each computer 902 communicating over network 930. Further, the term “client,” “user,” and other appropriate terminology may be used interchangeably as appropriate without departing from the scope of this disclosure. Moreover, this disclosure contemplates that many users may use one computer 902, or that one user may use multiple computers 902.

Described implementations of the subject matter can include one or more features, alone or in combination.

For example, in a first implementation, a computer-implemented method, comprising: normalizing parking-related statistical and real-time data and data received from routing data providers as normalized data; calculating, by a computer using the normalized data, a probability for parking space availability in given geographical segments for a selected destination; calculating routes to available parking, probability, and an estimated time to park (ETP)=estimated time to drive around (ETDA)+estimated time to walk (ETW) using the normalized statistical data and the selected destination; and evaluating the calculated routes to available parking in combination with user preferences to rank the calculated routes to available parking; and initiating the ranked routes to available parking in a graphical user interface (GUI).

The foregoing and other described implementations can each optionally include one or more of the following features:

A first feature, combinable with any of the following features, wherein the parking-related statistical and real-time data includes data from one or more of mobile device sensors, street sensors, image analysis, geographic information system and mapping, and crowd sourcing data.

A second feature, combinable with any of the previous or following features, further comprising aggregating the parking-related statistical and real-time data.

A third feature, combinable with any of the previous or following features, wherein the probability is calculated according to one or more of time, day, and date.

A fourth feature, combinable with any of the previous or following features, further comprising filtering the given geographical segments according to a threshold.

A fifth feature, combinable with any of the previous or following features, further comprising storing the normalized data in a database for access by a segment probability calculator used for the calculation of parking space probability.

A sixth feature, combinable with any of the previous or following features, wherein the ranking of the calculated routes is based on dynamic pricing.

In a second implementation, a non-transitory, computer-readable medium storing one or more instructions executable by a computer system to perform operations comprising: normalizing parking-related statistical and real-time data and data received from routing data providers as normalized data; calculating, by a computer using the normalized data, a probability for parking space availability in given geographical segments for a selected destination; calculating routes to available parking, probability, and an estimated time to park (ETP)=estimated time to drive around (ETDA)+estimated time to walk (ETW) using the normalized statistical data and the selected destination; and evaluating the calculated routes to available parking in combination with user preferences to rank the calculated routes to available parking; and initiating the ranked routes to available parking in a graphical user interface (GUI).

The foregoing and other described implementations can each optionally include one or more of the following features:

A first feature, combinable with any of the following features, wherein the parking-related statistical and real-time data includes data from one or more of mobile device sensors, street sensors, image analysis, geographic information system and mapping, and crowd sourcing data.

A second feature, combinable with any of the previous or following features, further comprising one or more instructions to aggregate the parking-related statistical and real-time data.

A third feature, combinable with any of the previous or following features, wherein the probability is calculated according to one or more of time, day, and date.

A fourth feature, combinable with any of the previous or following features, further comprising one or more instructions to filter the given geographical segments according to a threshold.

A fifth feature, combinable with any of the previous or following features, further comprising one or more instructions to store the normalized data in a database for access by a segment probability calculator used for the calculation of parking space probability.

A sixth feature, combinable with any of the previous or following features, wherein the ranking of the calculated routes is based on dynamic pricing.

In a third implementation, a computer-implemented system, comprising: a computer memory; and a hardware processor interoperably coupled with the computer memory and configured to perform operations comprising: normalizing parking-related statistical and real-time data and data received from routing data providers as normalized data; calculating, by a computer using the normalized data, a probability for parking space availability in given geographical segments for a selected destination; calculating routes to available parking, probability, and an estimated time to park (ETP)=estimated time to drive around (ETDA)+estimated time to walk (ETW) using the normalized statistical data and the selected destination; and evaluating the calculated routes to available parking in combination with user preferences to rank the calculated routes to available parking; and initiating the ranked routes to available parking in a graphical user interface (GUI).

The foregoing and other described implementations can each optionally include one or more of the following features:

A first feature, combinable with any of the following features, wherein the parking-related statistical and real-time data includes data from one or more of mobile device sensors, street sensors, image analysis, geographic information system and mapping, and crowd sourcing data.

A second feature, combinable with any of the previous or following features, further configured to aggregate the parking-related statistical and real-time data.

A third feature, combinable with any of the previous or following features, wherein the probability is calculated according to one or more of time, day, and date.

A fourth feature, combinable with any of the previous or following features, further configured to filter the given geographical segments according to a threshold.

A fifth feature, combinable with any of the previous or following features, further configured to store the normalized data in a database for access by a segment probability calculator used for the calculation of parking space probability.

A sixth feature, combinable with any of the previous or following features, wherein the ranking of the calculated routes is based on dynamic pricing.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Implementations of the subject matter described in this specification can be implemented as one or more computer programs, that is, one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal, for example, a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data may be less than 1 ms, less than 1 sec., less than 5 secs., etc. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” or “electronic computer device” (or equivalent as understood by one of ordinary skill in the art) refer to data processing hardware and encompass all kinds of apparatus, devices, and machines for processing data, including by way of example, a programmable processor, a computer, or multiple processors or computers. The apparatus can also be or further include special purpose logic circuitry, for example, a central processing unit (CPU), an FPGA (field programmable gate array), or an ASIC (application-specific integrated circuit). In some implementations, the data processing apparatus or special purpose logic circuitry (or a combination of the data processing apparatus or special purpose logic circuitry) may be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example LINUX, UNIX, WINDOWS, MAC OS, ANDROID, IOS, or any other suitable conventional operating system.

A computer program, which may also be referred to or described as a program, software, a software application, a module, a software module, a script, or code can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third-party services, components, libraries, and such, as appropriate. Conversely, the features and functionality of various components can be combined into single components as appropriate. Thresholds used to make computational determinations can be statically, dynamically, or both statically and dynamically determined.

The methods, processes, logic flows, etc. described in this specification can be performed by one or more programmable computers executing one or more computer programs to perform functions by operating on input data and generating output. The methods, processes, logic flows, etc. can also be performed by, and apparatus can also be implemented as, special purpose logic circuitry, for example, a CPU, an FPGA, or an ASIC.

Computers suitable for the execution of a computer program can be based on general or special purpose microprocessors, both, or any other kind of CPU. Generally, a CPU will receive instructions and data from a read-only memory (ROM) or a random access memory (RAM), or both. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable storage device, for example, a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, for example, erasable programmable read-only memory (EPROM), electrically erasable programmable read-only memory (EEPROM), and flash memory devices; magnetic disks, for example, internal hard disks or removable disks; magneto-optical disks; and CD-ROM, DVD+/−R, DVD-RAM, and DVD-ROM disks. The memory may store various objects or data, including caches, classes, frameworks, applications, backup data, jobs, web pages, web page templates, database tables, repositories storing dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, for example, a CRT (cathode ray tube), LCD (liquid crystal display), LED (Light Emitting Diode), or plasma monitor, for displaying information to the user and a keyboard and a pointing device, for example, a mouse, trackball, or trackpad by which the user can provide input to the computer. Input may also be provided to the computer using a touchscreen, such as a tablet computer surface with pressure sensitivity, a multi-touch screen using capacitive or electric sensing, or other type of touchscreen. Other kinds of devices can be used to provide for interaction with a user as well; for example, feedback provided to the user can be any form of sensory feedback, for example, visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or “GUI,” may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons. These and other UI elements may be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n or 802.20 (or a combination of 802.11x and 802.20 or other protocols consistent with this disclosure), all or a portion of the Internet, or any other communication system or systems at one or more locations (or a combination of communication networks). The network may communicate with, for example, Internet Protocol (IP) packets, Frame Relay frames, Asynchronous Transfer Mode (ATM) cells, voice, video, data, or other suitable information (or a combination of communication types) between network addresses.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although features may be described above as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the implementations described above should not be understood as requiring such separation or integration in all implementations, and it should be understood that the described program components and systems can generally be integrated together in a single software product or packaged into multiple software products.

Accordingly, the above description of example implementations does not define or constrain this disclosure. Other changes, substitutions, and alterations are also possible without departing from the spirit and scope of this disclosure.

Furthermore, any claimed implementation below is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A computer-implemented method, comprising:
normalizing parking-related statistical and real-time data and data received from routing data providers as normalized data;
calculating, by a computer using the normalized data, a probability for parking space availability in given geographical segments for a selected destination;
calculating routes to available parking, probability, and an estimated time to park (ETP)=estimated time to drive around (ETDA)+estimated time to walk (ETW) using the normalized statistical data and the selected destination; and
evaluating the calculated routes to available parking in combination with user preferences to rank the calculated routes to available parking; and
initiating the ranked routes to available parking in a graphical user interface (GUI).

2. The computer-implemented method of claim 1, wherein the parking-related statistical and real-time data includes data from one or more of mobile device sensors, street sensors, image analysis, geographic information system and mapping, and crowd sourcing data.

3. The computer-implemented method of claim 2, further comprising aggregating the parking-related statistical and real-time data.

4. The computer-implemented method of claim 1, wherein the probability is calculated according to one or more of time, day, and date.

5. The computer-implemented method of claim 1 further comprising filtering the given geographical segments according to a threshold.

6. The computer-implemented method of claim 1, further comprising storing the normalized data in a database for access by a segment probability calculator used for the calculation of parking space probability.

7. The computer-implemented method of claim 1, wherein the ranking of the calculated routes is based on dynamic pricing.

8. A non-transitory, computer-readable medium storing one or more instructions executable by a computer system to perform operations comprising:
normalizing parking-related statistical and real-time data and data received from routing data providers as normalized data;
calculating, by a computer using the normalized data, a probability for parking space availability in given geographical segments for a selected destination;
calculating routes to available parking, probability, and an estimated time to park (ETP)=estimated time to drive around (ETDA)+estimated time to walk (ETW) using the normalized statistical data and the selected destination; and
evaluating the calculated routes to available parking in combination with user preferences to rank the calculated routes to available parking; and
initiating the ranked routes to available parking in a graphical user interface (GUI).

9. The non-transitory, computer-readable medium of claim 8, wherein the parking-related statistical and real-time data includes data from one or more of mobile device sensors, street sensors, image analysis, geographic information system and mapping, and crowd sourcing data.

10. The non-transitory, computer-readable medium of claim 9, further comprising one or more instructions to aggregate the parking-related statistical and real-time data.

11. The non-transitory, computer-readable medium of claim 8, wherein the probability is calculated according to one or more of time, day, and date.

12. The non-transitory, computer-readable medium of claim 8, further comprising one or more instructions to filter the given geographical segments according to a threshold.

13. The non-transitory, computer-readable medium of claim 8, further comprising one or more instructions to store the normalized data in a database for access by a segment probability calculator used for the calculation of parking space probability.

14. The non-transitory, computer-readable medium of claim 8, wherein the ranking of the calculated routes is based on dynamic pricing.

15. A computer-implemented system, comprising:
a computer memory; and
a hardware processor interoperably coupled with the computer memory and configured to perform operations comprising:
normalizing parking-related statistical and real-time data and data received from routing data providers as normalized data;
calculating, by a computer using the normalized data, a probability for parking space availability in given geographical segments for a selected destination;
calculating routes to available parking, probability, and an estimated time to park (ETP)=estimated time to drive around (ETDA)+estimated time to walk (ETW) using the normalized statistical data and the selected destination; and
evaluating the calculated routes to available parking in combination with user preferences to rank the calculated routes to available parking; and
initiating the ranked routes to available parking in a graphical user interface (GUI).

16. The computer-implemented system of claim 15, wherein the parking-related statistical and real-time data includes data from one or more of mobile device sensors, street sensors, image analysis, geographic information system and mapping, and crowd sourcing data, and wherein the parking-related statistical and real-time data is aggregated.

17. The computer-implemented system of claim 15, wherein the probability is calculated according to one or more of time, day, and date.

18. The computer-implemented system of claim 15, further configured to filter the given geographical segments according to a threshold.

19. The computer-implemented system of claim 15, further configured to store the normalized data in a database for access by a segment probability calculator used for the calculation of parking space probability.

20. The computer-implemented system of claim 15, wherein the ranking of the calculated routes is based on dynamic pricing.
